(19) United States
(12) Patent Application Publication
(10) Pub. No.: US 2008/0210776 A1
(43) Pub. Date: Sep. 4, 2008

(54) Method for draining a fuel storage of a fuel-injected system and corresponding device

(75) Inventors: Uwe Gerstberger, Ingolstadt (DE); Michael Zimmermann, Ingolstadt (DE)

Correspondence Address: STEVENS DAVIS LLP, 1615 L STREET NW, SUITE 850, WASHINGTON, DC, 20036, US

(73) Assignee: Audi AG, Ingolstadt (DE)

(21) Appl. No.: 12/010,816

(22) Filed: Jan. 30, 2008

(30) Foreign Application Priority Data
Jan. 31, 2007 (DE) 10 2007 004 775.6

(51) Int. Cl. B05B 9/00

(52) U.S. Cl. 239/126

(57) ABSTRACT

The invention relates to a method for draining a fuel storage of an injection system of an internal combustion engine for an automobile, particularly a motor vehicle, having at least one injection valve. It is provided that the draining is carried out by means of suctioning off the fuel, wherein the injection valve is placed into the open position, or is placed into the open position at least once for venting the injection system during the suctioning off process. The invention further relates to a corresponding device.

### CROSS-REFERENCE TO RELATED APPLICATIONS

This application claims priority from German Application No. 10 2007 004 775.6 filed Jan. 31, 2007, hereby incorporated by reference in its entirety.

The invention relates to a method for draining a fuel storage of an injection system of an internal combustion engine for an automobile, particularly a motor vehicle, having at least one injection valve.

### BACKGROUND OF THE INVENTION

Whenever work, such as rebuilding, repairs, and disassemblies of the internal combustion machine having a fuel injection system must be performed at a repair shop, the internal combustion engine, including the fuel injection system, must be separated from a fuel tank, and from a fuel supply system having at least one fuel line, before this type of work commences. In order to avoid the release of any fuel vapors and fuel, which may pose a health risk, the fuel storage of the fuel injection system must also be depressurized and drained when a tank injection (common rail) is present. In order to relieve pressure in the fuel storage, it is common, for example, to loosen the threaded connector attached thereto. This reduces the pressure inside of the fuel storage to atmospheric pressure, which, during the operation of the internal combustion engine—and even for a longer period of time afterward—is more than 100 bars. However, loosening the threaded connector has the disadvantage that usually fuel discharges uncontrollably into the environment, and may pose a health risk.

In addition to this method of relieving pressure and draining the fuel storage, other methods are also known, wherein the fuel from the fuel storage of the fuel injection system is drained into the fuel tank before disassembling the fuel line. DE 103 53 141 A1 discloses a method, wherein a piston in an unlit cylinder of the internal combustion engine is positioned so that compression pressure is built in the cylinder, which drains the fuel from the fuel storage of the fuel injection system into the fuel tank.

In many cases the internal combustion engine has already been separated from the fuel supply system due to previous working steps performed on the internal combustion engine. It is therefore the task of the invention of providing a method and a corresponding device, which ensures a safe and complete draining of the fuel storage, even in this situation.

### SUMMARY OF THE INVENTION

In order to solve this task it is provided that the draining is carried out by means of suctioning off the fuel, wherein during the suctioning off process the injection valve is placed into the open position, or is placed into the open position at least once for venting the fuel injection system. After separating the internal combustion engine having the injection system from the fuel supply system (low-pressure system), particularly the following process steps are performed: connecting a fuel suction line that is connected to a suction pump, and particularly is connected to a fuel reception tank, to the injection system; connecting an electric connecting line connected to an electric circuit for generating electric impulses for an input signal to be performed for opening the injection valve, for the impulse transmission to the internal combustion engine; suctioning off the fuel from the injection system, wherein the injection valve is placed into the open position, or is placed into the open position at least once for venting the injection system before the suctioning off process. This causes the injection valves to be opened in turn, for example, in the manner of intervals.

Further, it is advantageously provided that the internal combustion engine has at least one outlet valve, and/or at least one inlet valve, which is open, or is placed into the open position, or is placed into the open position at least once during the suctioning off process. In internal combustion engines having a multitude of cylinders, as is common in automobiles; particularly motor vehicles, at least one of the inlet valves or of the outlet valves of the cylinder of the internal combustion engine is open at any given time. In an internal combustion engine, in which this is not the case, such as, for example, in an internal combustion engine having only one cylinder, at least one inlet or outlet valve must be placed into the open position. This can be achieved, for example, by means of rotating the crank shaft.

The invention further relates to a device for draining a fuel storage of an injection system with an internal combustion engine for an automobile, particularly a motor vehicle, having at least one injection valve. It is provided that the device has a fuel suction line that can be connected to the injection system, a suction pump, and an electric circuit for generating electric impulses for an input signal to be performed for opening the injection valve, as well as an electric connecting line for the electric connection to the internal combustion engine to be carried out for the impulse transmission. Such a device provides the advantage that the draining of the fuel storage of the injection system is possible safely and completely, even if the internal combustion engine having the injection system has already been separated from a fuel supply system having a fuel tank, preferably a fuel supply system of a motor vehicle. In order to drain the fuel storage, particularly after the internal combustion engine has already been separated from the fuel supply system, the following steps are provided: connecting a fuel suction line that is connected to a suction pump to the injection system; connecting an electric connecting line connected to an electric circuit for generating electric impulses for transmitting these impulses to the internal combustion engine; suctioning off the fuel from the injection system, wherein the injection valve is placed into the open position, or is placed into the open position at least once for venting the injection system before the suctioning off process.

It is particularly provided that the device is embodied as a portable unit. For this purpose, this portable unit particularly has dimensions such that it may be effortlessly carried by a single person. Furthermore, the device embodied as a portable unit can be operated in a self-sufficient manner, for which purpose it has its own electrical storage, such as a rechargeable battery. For the embodiment as a portable unit, the device is arranged in a case, or a trolley. A trolley is to be understood as a case-like housing with wheels (rolling suitcase), particularly with a handle for pulling the trolley while walking.

According to a further development of the invention it is provided that the device has a fuel reception tank. The fuel reception tank is connected to the fuel suction line, and has an outlet valve for draining.

It is advantageously provided that the fuel reception tank has a volume that is larger than the fuel amount in the injection system. Depending on the type of internal combustion engine, the injection system has about 50 to 200 ccm of fuel. The fuel reception tank of the device is therefore dimensioned such that it may accommodate at least one fuel load of an injection system.

Finally, it is advantageously provided that the fuel reception tank has a volume that is smaller than the volume of a fuel tank of the motor vehicle. By means of this limitation of the volume of the fuel reception tank, an adequately good manageability of the entire device for draining the fuel storage is achieved. If the device is embodied as a portable unit, an acceptable weight that can be carried is provided, even if the fuel reception tank is full. The fuel reception tank particularly has a volume (reception volume) of 1 to 2 liters.

### BRIEF DESCRIPTION OF THE DRAWING

FIG. 1 is a diagrammatic view of a device for draining a fuel storage of an injection system of an internal combustion engine for a motor vehicle.

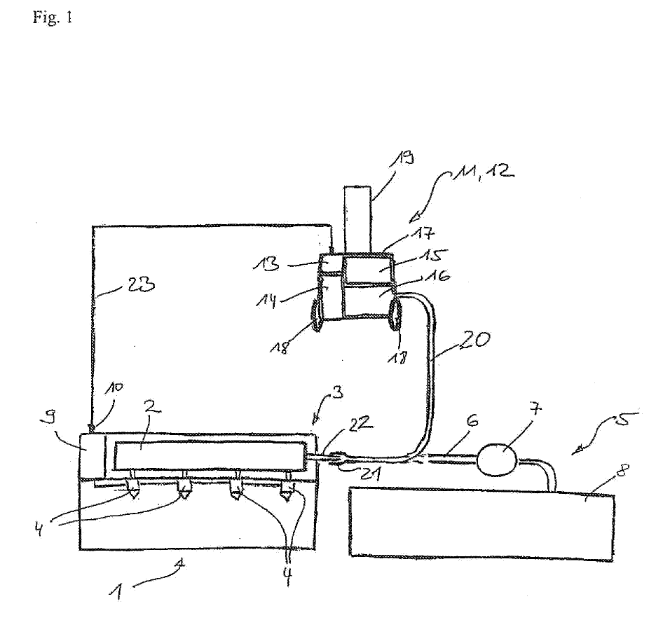

### DETAILED DESCRIPTION OF PREFERRED EMBODIMENTS OF THE INVENTION

The figure illustrates an internal combustion engine 1 for a not illustrated motor vehicle with an injection system 3 having a fuel storage (common rail) 2, to which a number of injection valves 4 corresponding to the number of cylinders is assigned. For the fuel supply of the internal combustion engine 1 the same is connected to a fuel supply system 5. The fuel supply system 5 has a fuel line 6, a fuel pump 7, and a fuel tank 8, wherein the fuel supply system 5 is connected to the internal combustion engine 1, or its injection system 3, respectively, by means of the fuel line 6 (dotted lines). The internal combustion engine 1 has a control device 9 which, among other things, triggers the injection valves 4, and an electric connection 10, via which control impulses can be imputed to the individual injection valves 4. In order to drain the fuel storage 2 of the injection system 3, a device 11 is provided in the embodiment example illustrated in the figure, which is embodied as a portable unit 12. The portable unit 12 has an electric circuit 13 for generating electric impulses for opening the injection valves 4, an electrically driven suction pump 14, a rechargeable battery 15 for the self-sufficient power supply of the device 11, and a fuel reception tank 16. Furthermore, the portable unit 12 has a housing 17 in the manner of a trolley for the enclosure of the electric circuit 13, the suction pump 14, the battery 15, and the fuel reception tank 16. On its edge end region, the housing 17 has two wheels 18, and a handle 19 in its top region. In order to connect the device 11 embodied as a portable unit 12 to the internal combustion engine 1, the device 11 has a fuel suction line 20 with a connection 21 that can be connected to a connection 22 of the injection system 3 of the internal combustion engine 1. For the electric contacting of the electric circuit 13 with the internal combustion engine 1 (for example, via electrical connection contacts 10 of the injection system 3 arranged on the control device 9), the device 11 has at least one electric connecting line 23.

This results in the following function of the device 11, or the following method for draining the fuel storage 2 of the injection system 3, respectively: in order to carry out any rebuilding, repairs, or disassemblies of components of the internal combustion engine 1, the same is usually separated from the associated fuel supply system 5 in the area of a fuel line 6. If work has to be performed on the injection system 3, or any work for which the injection system 3 must be disassembled, the fuel remaining in the injection system 3, particularly in the fuel storage 2 of the injection system 3, is removed by means of the device 11. For this purpose, the fuel suction line 20 of the device 11 is connected to the injection system 2. Various adapters are provided for various types of internal combustion engines. Subsequently, the internal combustion engine 1 is connected, particularly at the connection contacts 10 of the control device 9, or the separate connection contacts 10 for triggering the injection valves 4, to the electric connecting line 23 of the device 11. After startup of the device 11, in which the suction pump 14 starts, at least one of the injection valves 4 is placed into the open position, or is placed into the open position at least once while the suction pump 14 suctions off the fuel from the fuel storage 2 by an electric impulse generated by the electric circuit 13, and transmitted via the electric connecting line 23. Therefore, either at least one of the injection valves 4 is permanently open, or at least one of the injection valves 4 is opened in the manner of intervals, or the injection valves 4 are opened in turn in the manner of intervals during the suctioning time. After completion of the suctioning off process, particularly if no further fuel can be suctioned off by means of the respective method, the device 11 is turned off, and the connections (connecting line 23 and fuel suction line 20) are removed from the connection contact 10, or from the connection 22 of the internal combustion engine 1, respectively. The sequence of these process steps, however, is not mandatory. In particular the sequence of the connecting/removing of the fuel suction line 20 and of the connection line 23 is not specified.

The following advantages are achieved: by means of the method according to the invention, and the device 11 according to the invention, the fuel storage 2 of the injection system 3 of an internal combustion engine 1 can be completely drained in a safe manner without any risk. The content of the fuel storage 1 is particularly placed into the fuel reception tank 16, which enables the handling of the fuel without any risk. If the device 11 is particularly embodied as a portable unit 12, maneuverability is facilitated and such a device 11 is rendered particularly flexible. Another advantage of the method according to the invention, and the device 11 according to the invention is the possibility of also suctioning off fuel vapors in addition to liquid fuel, which are subsequently confined in the fuel reception tank 16. The device 11 according to the invention, particularly the device 11 having a fuel reception tank 16, reduces any health risks due to escaping fuel vapors and fuel. Furthermore, the risk of explosion and/or fie are significantly reduced.

### LIST OF REFERENCE SYMBOLS

1 internal combustion engine
2 fuel storage
3 injection system
4 injection valve
5 fuel supply system
6 fuel line
7 fuel pump
8 fuel tank
9 control device
10 connection contact
11 device
12 unit
13 circuit
14 suction pump
15 battery
16 fuel reception tank
17 housing
18 wheel
19 handle
20 fuel suction line
21 connection adapter
22 connection
23 connecting line

1. A method for draining a fuel storage of an injection system of an internal combustion engine for an automobile, particularly a motor vehicle, having at least one injection valve, comprising placing said injection valve in an open position and applying a negative pressure to said open valve to vent fuel and fuel vapors therefrom.

2. The method according to claim 1, wherein the internal combustion engine has at least one outlet valve, and/or at least one inlet valve, which is open during the venting process, or is placed into the open position, or is placed into the open position at least once.

3. A device for draining a fuel storage of an injection system of an internal combustion engine for an automobile, particularly a motor vehicle, having at least one injection valve, comprising:
means for applying a negate e pressure to said injection system to vent fuel and fuel vapors therefrom; and
means for applying electrical impulses to open said injection valve.

4. The device according to claim 3 wherein said device comprises a portable unit.

5. The device according to claim 3 wherein said device includes a fuel reception tank.

6. The device according to claim 5 wherein said, fuel reception tank has a volume that is larger than the fuel amount in the injection system.

7. The device according to claims 5 wherein said, fuel reception tank has a volume that is smaller than the volume of a fuel tank of the motor vehicle.
